(19) United States
(12) Patent Application Publication
(10) Pub. No.: US 2011/0100979 A1
(43) Pub. Date: May 5, 2011

(54) MANUFACTURING METHOD FOR ROD MEMBER OF THREE-DIMENSIONAL STATICALLY INDETERMINATE TRUSS STRUCTURE

(76) Inventors: Chi-Wah KEONG, Kaohsiung City (TW); Tzyy-Ker Sue, Kaohsiung City (TW); Hung-Hsu Hsu, Kaohsiung County (TW); Dian-Yong Lin, Kaohsiung County (TW)

(21) Appl. No.: 12/637,206

(22) Filed: Dec. 14, 2009

(30) Foreign Application Priority Data
Nov. 4, 2009 (TW) 098137423

(51) Int. Cl. B23K 13/01

(52) U.S. Cl. 219/617

(57) ABSTRACT

A manufacturing method for a rod member of a three-dimensional statically indeterminate truss structure is provided, which includes the following steps. A first conical connection element is provided, which has a guide slot and a coupling portion on a front and a rear end respectively. A first screw connection is made to penetrate from the coupling portion of the first conical connection element, such that a screw portion of the first screw connection penetrates out of the guide slot, and a head portion of the first screw connection is confined within the first conical connection element. The coupling portion of the first conical connection element is aligned and engaged with a first end opening of a tube member, and the first end opening of the tube member is joined to an engaging portion in the coupling portion of the first conical connection element by applying a magnetic pulse welding technique.

### CROSS-REFERENCE TO RELATED APPLICATION

This application claims the benefit of Taiwan Patent Application No. 098137423, filed on Nov. 4, 2009, which is hereby incorporated by reference for all purposes as if fully set forth herein.

### BACKGROUND OF THE INVENTION

1. Field of the Invention

The present invention relates to a manufacturing method for a rod member of a three-dimensional statically indeterminate truss structure, and more particularly to a manufacturing method for a rod member of a three-dimensional statically indeterminate truss structure by applying a magnetic pulse welding (MPW) means.

2. Related Art

Since a three-dimensional truss system has been proposed by a German company “MERO” in the 1930s, amazing construction structures are created one after another by using the three-dimensional truss. In the Osaka Word Exposition in the year of 1970, the three-dimensional truss fully shows the special structural glamour. The three-dimensional truss system is introduced into Taiwan during the 1990s, and the most famous cases include mass rapid transit (MRT) stations along the MRT Danshui line of Taipei and Terminal II of the Taiwan Taoyuan International Airport. In the above cases, it is easy to find out the excellent structures accomplished by the three-dimensional truss, that is, the hall creates a wide-open space without pillars. In recent years, as the structural system has been developed rapidly, the three-dimensional truss is not only combined with new systems, but also still attracts most architects and structure engineers due to its excellent structure characteristics and variety feature.

Referring to FIG. 1, the three-dimensional truss used in the conventional statically indeterminate structure, for example, a three-dimensional truss used in the building or exhibition place, is formed by a sphere-like element 10 made of a steel iron material or an aluminum alloy material and including a plurality of joint structures, and a plurality of rod members 13 screwed into screw holes 11 of the sphere-like element 10 after being sleeved in a sleeve element 12 respectively. The sleeve element 12 is rotated to drive a screw connection 14 on the rod member 13. A tube body 15 and a conical connection element 16 of the rod member 13 are generally combined by using arc welding or adhesive manner. Usually, if they are made of the same material, they are processed by using the arc welding manner, and as a result, unaesthetic welds pass 17 is appeared at a joining position. The light structure made of unlike materials is processed by the adhering and screwing manner. The former manner is a process which produces light harm, welding and grinding noises, and other long-term damages for eyes, skin, and human body, as well as the environment, in which a welding time is slightly long (in an experiment using a tube with an external diameter of 40 mm, the welding time is approximately 24 seconds), and it is relatively difficult to weld the above two portions together when they are made of unlike materials. For the latter manner, the strength is rather low; more jigs are required during the mass production; a curing time is rather long (the curing time for the adhesion process of a adhesion member in a laboratory furnace is approximately 30 minutes, and the curing time during the production is multiples of the curing time in this situation); the manual coating process has a low stability; common manufacturers may be worried about aging and deterioration of the joining strength in long-term use; as the strip direction of the adhesion member is rather weak, the optimized design is hard to achieve. Regardless, the welding material or adhesive are used in the above two manners, such that the long-term material cost is quite high.

### SUMMARY OF THE INVENTION

The present invention is directed to a manufacturing method for a rod member of a three-dimensional statically indeterminate truss structure, which requires no filling material.

In order to achieve the above object, the present invention provides a manufacturing method for a rod member of a three-dimensional statically indeterminate truss structure, which includes the following steps. Firstly, a first conical connection element is provided. Next, a first screw connection is made to penetrate into a coupling portion of the first conical connection element, such that a screw portion of the first screw connection penetrates out of a guide slot of the first conical connection element, and a head portion of the first screw connection is confined within the first conical connection element by the guide slot. Then, the coupling portion of the first conical connection element is engaged with a first end opening of a tube member, and the first end opening of the tube member is joined to the coupling portion of the first conical connection element by applying an magnetic pulse welding (MPW) means at an engaging position between the first end opening and the coupling portion.

The other end of the tube member, that is, a second end opening, may be engaged with a second conical connection element having a second screw connection penetrated therein, and may be joined to the second conical connection element by applying the MPW means.

The first conical connection element and the tube member and/or the second conical connection element and the tube member can be made of unlike metals.

Any one of the first conical connection element and the tube member is made of a non-metal material, and any one of the second conical connection element and the tube member is made of a non-metal material.

The coupling portion of the first conical connection element is engaged with the first end opening by using at least one joint formed on the coupling portion and/or the first end opening. Similarly, a coupling portion of the second conical connection element is engaged with the second end opening by using at least one joint formed on the coupling portion and/or the second end opening.

For efficacies of the present invention, the conical connection element and the tube member in the rod member of the three-dimensional truss according to the present invention are joined by applying the MPW manner, and the MPW means is environmental protective, and highly efficient (in an experiment, the welding time for the rod member is only about 56 μs), has a low power consumption, and requires no filling material. Furthermore, the means is quite appropriate for joining different materials, a joining appearance thereof does not cause pollution, a joining interface thereof is metallurgical bond and has an excellent joining strength, without an aging or strength deterioration problem in long term use, which is capable of improving a strength and an appearance quality of a three-dimensional truss after being applied to the three-dimensional truss in a public area.

### BRIEF DESCRIPTION OF THE DRAWINGS

FIG. 1 is a longitudinal cross-sectional view of a rod member and a sphere-like element of a three-dimensional truss in a welding method in the prior art;

FIG. 2 is an exploded cross-sectional view of an embodiment of a first conical connection element and a tube member of a rod member in a three-dimensional statically indeterminate truss structure according to the present invention;

FIG. 3 is a three-dimensional exploded view of an embodiment of a three-dimensional statically indeterminate truss structure according to the present invention;

FIG. 4 is a cross-sectional view of an embodiment of a first conical connection element and a second conical connection element engaged with a tube member of a rod member in a three-dimensional statically indeterminate truss structure according to the present invention;

FIG. 5 is a cross-sectional view of an embodiment of a first conical connection element or a second conical connection element engaged with a tube member in a rod member according to the present invention;

FIG. 6 is a cross-sectional view of an embodiment of a tube member engaged with a first conical connection element or a second conical connection element in a rod member according to the present invention;

FIG. 7 is a cross-sectional view of a first embodiment of a tube member in a rod member engaged with a step portion joint of a first conical connection element or a second conical connection element according to the present invention; and

FIG. 8 is a cross-sectional view of a second embodiment of a tube member in a rod member engaged with a step portion joint of a first conical connection element or a second conical connection element according to the present invention.

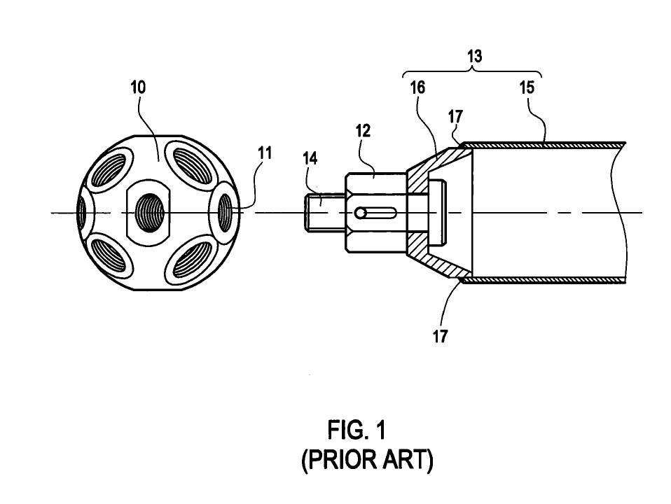

### DETAILED DESCRIPTION OF THE INVENTION

Embodiments of the present invention are described in detail below with reference to the accompanying drawings, and the accompanying drawings are simplified schematic views, and only schematically demonstrate a basic method or structure of the present invention. Therefore, merely elements or steps associated with the present invention are marked in the accompanying drawings, and the shown elements or steps are not depicted according to numbers, shapes, and size proportions in the actual implementation. The specification size during the actual implementation is a selective design, and the element layouts or steps may be more complicated.

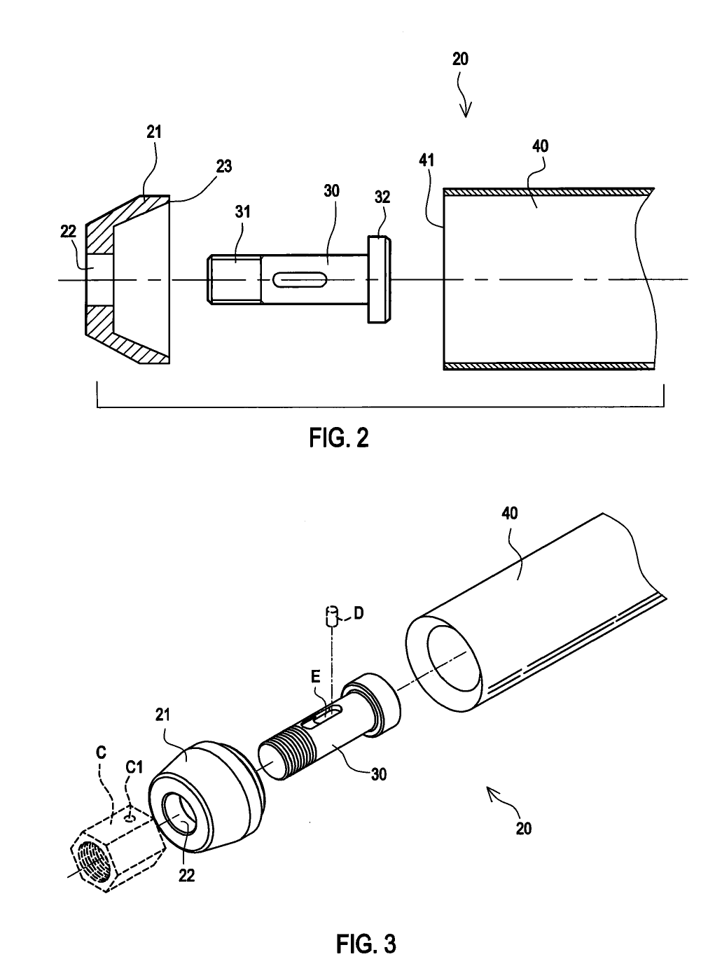

FIG. 2 is an exploded cross-sectional view of an embodiment of a first conical connection element and a tube member of a rod member in a three-dimensional statically indeterminate truss structure according to the present invention. Referring to FIG. 2, a manufacturing method for a rod member of a three-dimensional statically indeterminate truss structure in this embodiment includes the following steps.

A first conical connection element 21 is provided, which has a guide slot 22 and a coupling portion 23 disposed on a front and a rear end thereof respectively (Step S10).

A first screw connection 30 is made to penetrate from the coupling portion 23 of the first conical connection element 21, such that a screw portion 31 having screw threads of the first screw connection 30 penetrates out of the guide slot 22, and a head portion 32 of the first screw connection 30 is confined within the first conical connection element 21 by the guide slot 22 (Step S20).

The coupling portion 23 of the first conical connection element 21 is engaged with a first end opening 41 of a tube member 40, an inductance coil A is disposed surrounding an engaging position between the first end opening 41 and the coupling portion 23, and is coupled to a power source B to conduct a current, and the first end opening 41 of the tube member 40 is joined to the coupling portion 23 of the first conical connection element 21 by applying an MPW means (Step S30).

FIG. 3 is a three-dimensional exploded view of an embodiment of a three-dimensional statically indeterminate truss structure according to the present invention. Referring to FIG. 3, in the embodiment of the present invention, in the rod member 20, a sleeve element C having a pin hole C1 is sleeved into the first screw connection 30, then a pin D is inserted into the pin hole C1 and is stopped against a pin seat E disposed on the first screw connection 30, and the screw portion 31 of the first screw connection 30 is aligned with a screw hole of a sphere-like element (not shown), and then the sleeve element C is rotated by using a tool, so as to fixedly screw the first screw connection 30 on the sphere-like element.

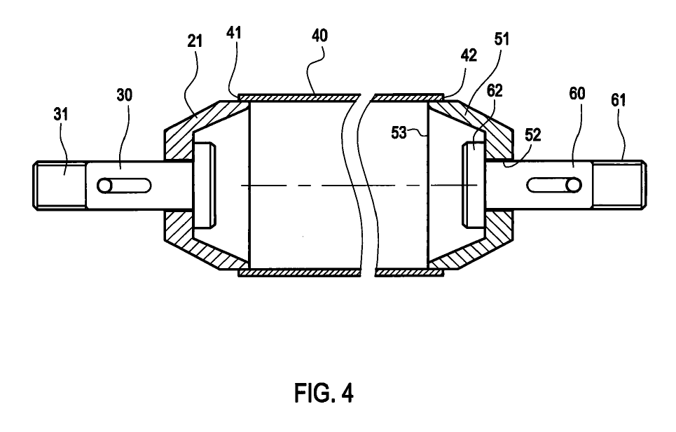

FIG. 4 is a cross-sectional view of an embodiment of a first conical connection element and a second conical connection element engaged with a tube member of a rod member in a three-dimensional statically indeterminate truss structure according to the present invention. Referring to FIG. 4, in this embodiment, the other end of the tube member 40, that is, a second end opening 42, is aligned and engaged with a second conical connection element 51 having a second screw connection 60 penetrated therein, so that a screw portion 61 having screw threads of the second screw connection 60 penetrates out of a guide slot 52, and a head portion 62 of the second screw connection 60 is confined within the second conical connection element 51 by the guide slot 52. Then, the second conical connection element 51 is joined to the tube member 40 by applying an MPW means.

In the above embodiment of the method, the first conical connection element 21 and the tube member 40 and/or the second conical connection element and the tube member are made of unlike metals.

Furthermore, in the above embodiment of the method, the first conical connection element or the tube member may be made of a non-metal material, and the second conical connection element or the tube member may also be made of a non-metal material.

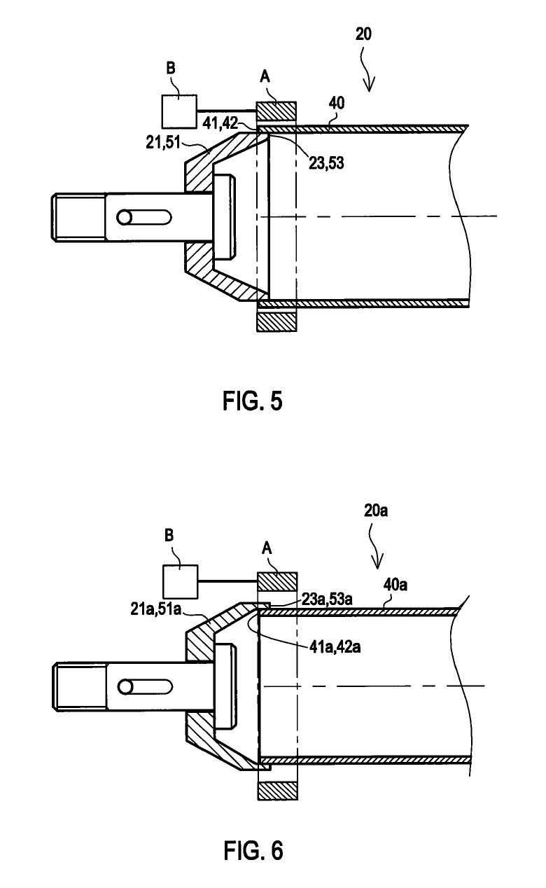

FIG. 5 is a cross-sectional view of an embodiment of a first conical connection element or a second conical connection element engaged with a tube member in a rod member according to the present invention. Referring to FIG. 5, in this embodiment, the coupling portion 23 (53) of the first conical connection element 21 (the second conical connection element 51) is engaged with the first end opening 41 (the second end opening 42) of the tube member 40 in the rod member 20 in a manner of engaging the first end opening 41 (the second end opening 42) on an external diameter of the coupling portion 23 (53), an inductance coil A coupled to a power source B is disposed surrounding an external diameter of the engaging position of the first end opening 41 (the second end opening 42), and then a current is conducted for performing the joining operation.

FIG. 6 is a cross-sectional view of an embodiment of a tube member engaged with a first conical connection element or a second conical connection element in a rod member according to the present invention. Referring to FIG. 6, in this embodiment, the coupling portion 23a (53a) of the first conical connection element 21a (the second conical connection element 51a) is engaged with the first end opening 41a (the second end opening 42a) of the tube member 40a in the rod member 20a in a manner of engaging the coupling portion 23a (53a) on an external diameter of the first end opening 41a (the second end opening 42a), an inductance coil A coupled to a power source B is disposed surrounding an external diameter of the engaging position of the coupling portion 23a (53a), and then a current is conducted for performing the joining operation.

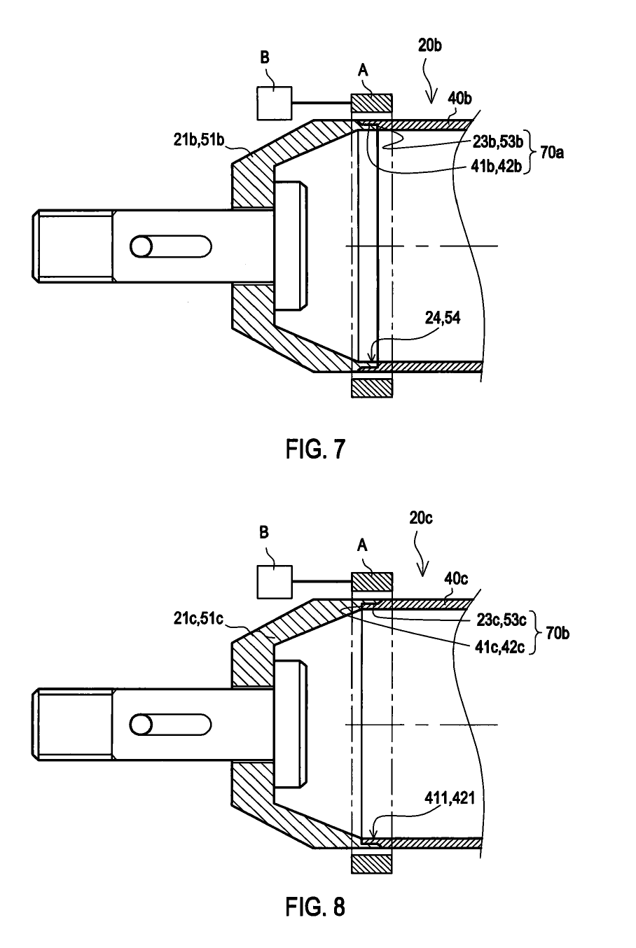

FIG. 7 is a cross-sectional view of a first embodiment of a tube member in a rod member engaged with a step portion joint of a first conical connection element or a second conical connection element according to the present invention. Referring to FIG. 7, in this embodiment, the coupling portion 23b (53b) of the first conical connection element 21b (the second conical connection element 51b) is engaged with the first end opening 41b (the second end opening 42b) of the tube member 40b in the rod member 20b by using at least one joint 70a formed on the coupling portion 23b (53b) and/or the first end opening 41b (the second end opening 42b), in which the joint 70a is an axially-extended step portion 24 (54) formed on the coupling portion 23b (53b) of the first conical connection element 21b (the second conical connection element 51b) and having an internal diameter being the same as that of the first end opening 41b (the second end opening 42b), and the first end opening 41b (the second end opening 42b) has an end face configuration matching with the step portion 24 (54), such that the step portion 24 (54) is embedded in the first end opening 41b (the second end opening 42b).

FIG. 8 is a cross-sectional view of a second embodiment of a tube member in a rod member engaged with a step portion joint of a first conical connection element or a second conical connection element according to the present invention. Referring to FIG. 8, in this embodiment, the coupling portion 23c (53c) of the first conical connection element 21c (the second conical connection element 51c) is engaged with the first end opening 41c (the second end opening 42c) of the tube member 40c in the rod member 20c by using at least one joint 70b formed on the coupling portion 23c (53c) and/or the first end opening 41c (the second end opening 42c), in which the joint 70b is an axially-extended step portion 411 (421) formed on the first end opening 41c (the second end opening 42c) and having an internal diameter being the same as that of the coupling portion 23c (53c) of the first conical connection element 21c (the second conical connection element 51c), and the coupling portion 23c (53c) of the first conical connection element 21c (the second conical connection element 51c) has an end face configuration matching with the step portion 411 (421), such that the step portion 411 (421) is embedded in the coupling portion 23c (53c).

In the above embodiments, as for efficacies of the present invention, the conical connection element and the tube member of the rod member in the three-dimensional truss are joined by applying the MPW manner, in which the MPW means has a fast actual welding time (in an experiment, the welding time for the rod member is only about 56 μs), and is used together with the industrial project and automatic production, and thus has an improved production efficiency as compared with a conventional joining manner, for example, an arc welding means or adhering process. Being superior to the arc welding means, the MPW means is quite appropriate for welding unlike materials, besides the same material. In terms of the product design and material selection, the MPW means is more flexible and diversified, such that products are developed towards a direction of reaching higher level and achieving higher value. Furthermore, in the present invention, in terms of the combination of different materials, the welding means of the present invention achieves a metallurgical bond interface, such that a stripe direction strength, long-term stability, anti-ultraviolet outdoor application, jig cost, and production efficiency are much better than that of the adhering process.

To sum up, the implementation manners or embodiments of the technical means adopted by the present invention for solving technical problems are thus described, which are not intended to limit the implementation scope of the present invention. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A manufacturing method for a rod member of a three-dimensional statically indeterminate truss structure, comprising:
providing a first conical connection element, wherein the first conical connection element has a guide slot and a coupling portion disposed on a front and a rear end thereof respectively;
making a first screw connection penetrate from the coupling portion of the first conical connection element, such that a screw portion having screw threads of the first screw connection penetrates out of the guide slot, and a head portion of the first screw connection is confined within the first conical connection element by the guide slot; and
engaging the coupling portion of the first conical connection element with a first end opening of the tube member, disposing an inductance coil surrounding an engaging position between the first end opening and the coupling portion, conducting a current, and joining the first end opening of the tube member to the coupling portion of the first conical connection element by applying a magnetic pulse welding (MPW) means.

2. The manufacturing method for a rod member of a three-dimensional statically indeterminate truss structure according to claim 1, wherein a second end opening of the tube member is engaged with a second conical connection element having a second screw connection penetrated therein, and is joined to the second conical connection element by applying the MPW means.

3. The manufacturing method for a rod member of a three-dimensional statically indeterminate truss structure according to claim 1, wherein the first conical connection element and the tube member are made of unlike metals.

4. The manufacturing method for a rod member of a three-dimensional statically indeterminate truss structure according to claim 2, wherein the second conical connection element and the tube member are made of unlike metals.

5. The manufacturing method for a rod member of a three-dimensional statically indeterminate truss structure according to claim 1, wherein the first conical connection element or the tube member is made of a non-metal material.

6. The manufacturing method for a rod member of a three-dimensional statically indeterminate truss structure according to claim 2, wherein the second conical connection element or the tube member is made of a non-metal material.

7. The manufacturing method for a rod member of a three-dimensional statically indeterminate truss structure according to claim 1, wherein the coupling portion of the first conical connection element is engaged with the first end opening by engaging the first end opening on an external diameter of the coupling portion of the first conical connection element.

8. The manufacturing method for a rod member of a three-dimensional statically indeterminate truss structure according to claim 2, wherein a coupling portion of the second conical connection element is engaged with the second end opening by engaging the second end opening on an external diameter of the coupling portion of the second conical connection element.

9. The manufacturing method for a rod member of a three-dimensional statically indeterminate truss structure according to claim 1, wherein the coupling portion of the first conical connection element is engaged with the first end opening by engaging the coupling portion on an external diameter of the first end opening.

10. The manufacturing method for a rod member of a three-dimensional statically indeterminate truss structure according to claim 2, wherein a coupling portion of the second conical connection element is engaged with the second end opening by engaging the coupling portion on an external diameter of the second end opening.

11. The manufacturing method for a rod member of a three-dimensional statically indeterminate truss structure according to claim 1, wherein the coupling portion of the first conical connection element is engaged with the first end opening by using at least one joint formed on the coupling portion of the first conical connection element and/or the first end opening.

12. The manufacturing method for a rod member of a three-dimensional statically indeterminate truss structure according to claim 2, wherein a coupling portion of the second conical connection element is engaged with the second end opening by using at least one joint formed on the coupling portion of the second conical connection element and/or the second end opening.

13. The manufacturing method for a rod member of a three-dimensional statically indeterminate truss structure according to claim 11, wherein the joint is an axially-extended step portion formed on the coupling portion of the first conical connection element and having an internal diameter being a same as an internal diameter of the first end opening, and the first end opening has an end face configuration matching with the step portion, such that the step portion is embedded in the first end opening.

14. The manufacturing method for a rod member of a three-dimensional statically indeterminate truss structure according to claim 12, wherein the joint is an axially-extended step portion formed on the coupling portion of the second conical connection element and having an internal diameter being a same as an internal diameter of the second end opening, and the second end opening has an end face configuration matching with the step portion, such that the step portion is embedded in the second end opening.

15. The manufacturing method for a rod member of a three-dimensional statically indeterminate truss structure according to claim 11, wherein the joint is an axially-extended step portion formed on the first end opening and having an internal diameter being a same as an internal diameter of the coupling portion of the first conical connection element, and the coupling portion of the first conical connection element has an end face configuration matching with the step portion, such that the step portion is embedded in the coupling portion of the first conical connection element.

16. The manufacturing method for a rod member of a three-dimensional statically indeterminate truss structure according to claim 12, wherein the joint is an axially-extended step portion formed on the second end opening and having an internal diameter being a same as an internal diameter of the coupling portion of the second conical connection element, and the coupling portion of the second conical connection element has an end face configuration matching with the step portion, such that the step portion is embedded in the coupling portion of the second conical connection element.
